(19) United States
(12) Patent Application Publication
(10) Pub. No.: US 2011/0131758 A1
(43) Pub. Date: Jun. 9, 2011

(54) DETACHABLE WHEEL SET FOR MOVING CASE

(76) Inventor: Hai-Huan Chiang, Taoyuan County (TW)

(21) Appl. No.: 12/913,776

(22) Filed: Oct. 28, 2010

(30) Foreign Application Priority Data
Dec. 9, 2009 (TW) 098223038

(51) Int. Cl. B60B 33/00

(52) U.S. Cl. 16/18 R

(57) ABSTRACT

A wheel set which is detachably mounted on a case is disclosed. The wheel set includes a wheal set, a binding strip and a fastening unit. The wheal set includes a mount plate and a wheel mounted thereon. The binding strip is a single Velcro strip having both a hook surface and a loop surface so as to bind up a case and fasten each other. The fastening unit is fixed on the mount plate and is a Velcro fastener corresponding to the binding strip, so that the wheal set can be detachably fastened on the case by fastening the fastening unit on the binding strip. Thus the case can be easily moved by the wheel set.

### BACKGROUND OF THE INVENTION

1. Technical Field

The invention relates to wheel sets, particularly to wheel set for cases.

2. Related Art

People always use a case for storing and moving things such as a bicycle, large musical instrument or a large quantity of books. The moving process usually makes users feel inconvenient because those cases containing things are cumbersome. It would be convenient for users if there could be a detachable wheel set for being mounted on the case to be moved.

### SUMMARY OF THE INVENTION

An object of the invention is to provide a wheel set for moving a case, which can be detachably fastened on the case to be moved can efficiently save time and effort.

To accomplish the above object, the detachable wheel set of the invention includes a binding strip and a wheel set. The binding strip removably binds up the case to be moved. The wheal set has a mount plate and a wheel mounted thereon and is detachably fixed on the binding strip. Thus the wheal set is detachably fastened on the case.

### BRIEF DESCRIPTION OF THE DRAWINGS

FIG. 1 is a perspective view of the first embodiment of the invention;

FIG. 2 is a side view of the first embodiment of the invention;

FIG. 3 is a bottom view of the second embodiment of the invention;

FIG. 4 is a top view of the third embodiment of the invention;

FIG. 5 is a cross-sectional view of the third embodiment of the invention; and

FIG. 6 is a schematic view of the second or third embodiment of the invention.

### DETAILED DESCRIPTION OF THE INVENTION

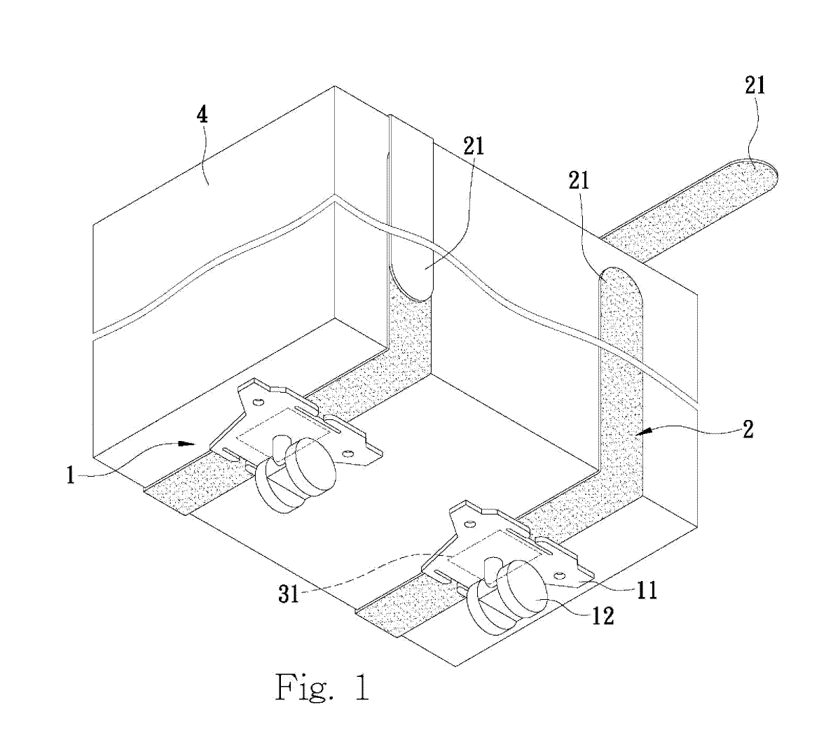

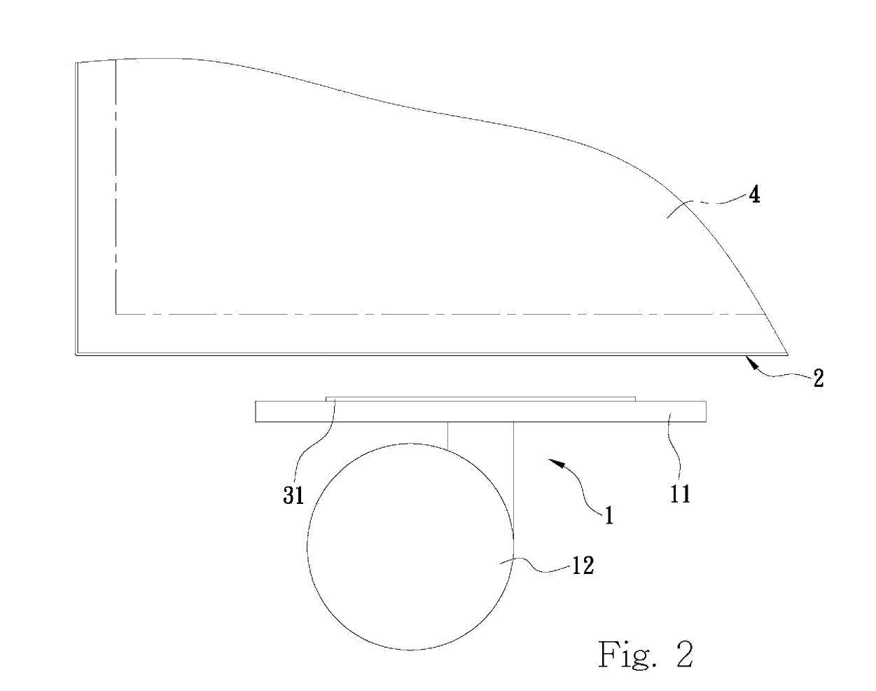

Please refer to FIGS. 1 and 2, which illustrate the first embodiment of the invention. The wheel set of the invention includes a wheel set 1, a binding strip 2 and a fastening unit 31. The wheel set 1 is detachably fixed on a case 4 to be moved.

The wheel set 1 is fixed on the binding strip 2 by the fastening unit 31. The wheel set 1 includes a mount plate 11 for supporting the case 4 and a wheel 12 mounted on the mount plate 11. The number of the wheel set 1 and binding strip 2 may be increased according practical demands such as size and/or weight of the case 4.

The binding strip 2 is a Velcro fastener and binds up the case 4 for being removably fastened by the wheel set 1. Preferably, the binding strip 2 is a single strip having both a hook surface and a loop surface. A majority of the binding strip 2 is either of the hook surface and loop surface, and a distal portion 21 of the binding strip 2 is the other either thereof. Thus the distal portion 21 may be fastened on the majority of the binding strip 2.

The fastening unit 31 is fixed on the mount plate 11. The fastening unit 31 is a Velcro fastener corresponding to the majority of the binding strip 2. Thus, the wheel set 1 can be detachably mounted on the case 4 by fastening the fastening unit 31 onto the majority of the binding strip 2, and the wheel set 1 can be removed after the case 4 has been completed the movement.

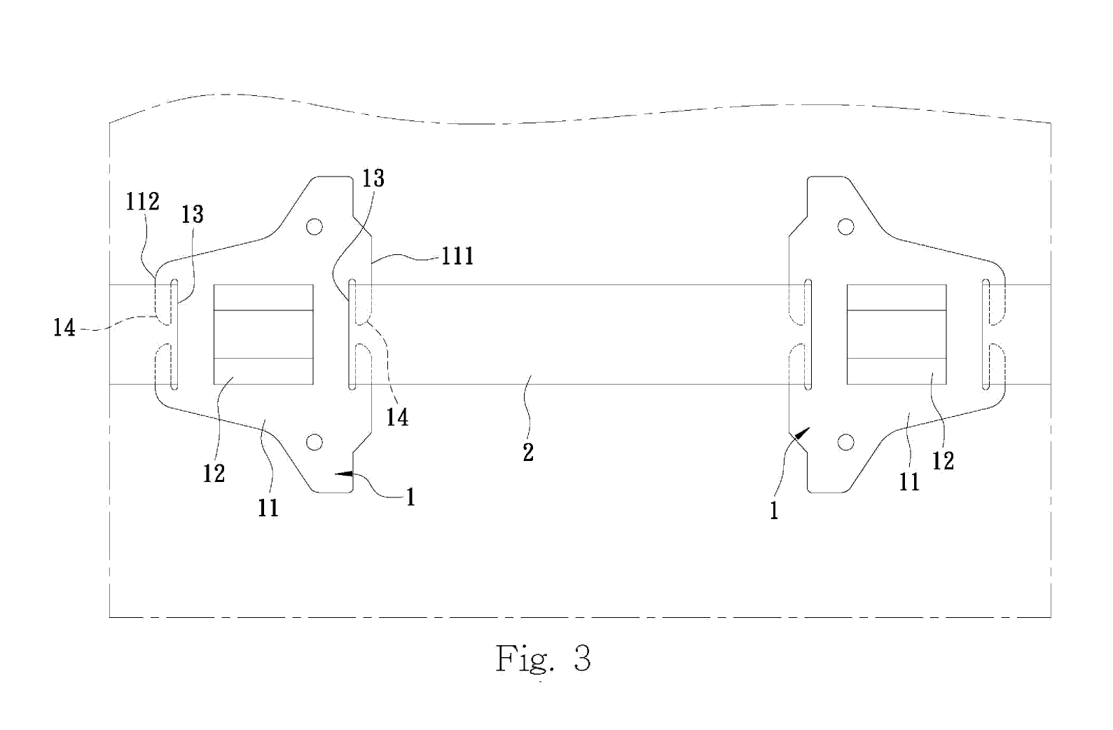

FIG. 3 shows the second embodiment of the invention. The second embodiment differs from the first embodiment by the connection between the mount plate 11 and the binding strip 2. In this embodiment, the mount plate 11 is provided with two parallel slots 13. Preferably, the mount plate 11 is further provided with two openings 14 separately communicating with the slots 13.

In this embodiment, the mount plate 11 is a substantial trapezoid in shape and has a long side 111 and a short side 112. These two slots 13 are located separately near the long side 111 and the short side 112. And the openings 14 separately penetrate the long side 111 and short side 112.

The binding strip 2 penetrates the mount plate 11 through the slots 13. The openings 14 allow the binding strip 2 to enter the slots 13. This will be convenient for assembling and detaching the binding strip 2.

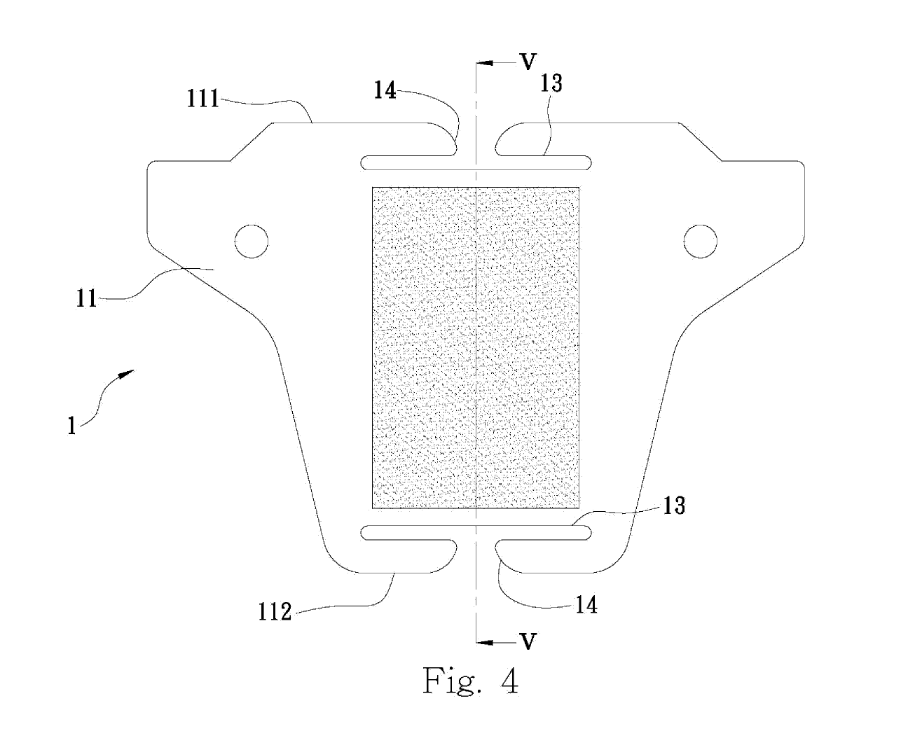

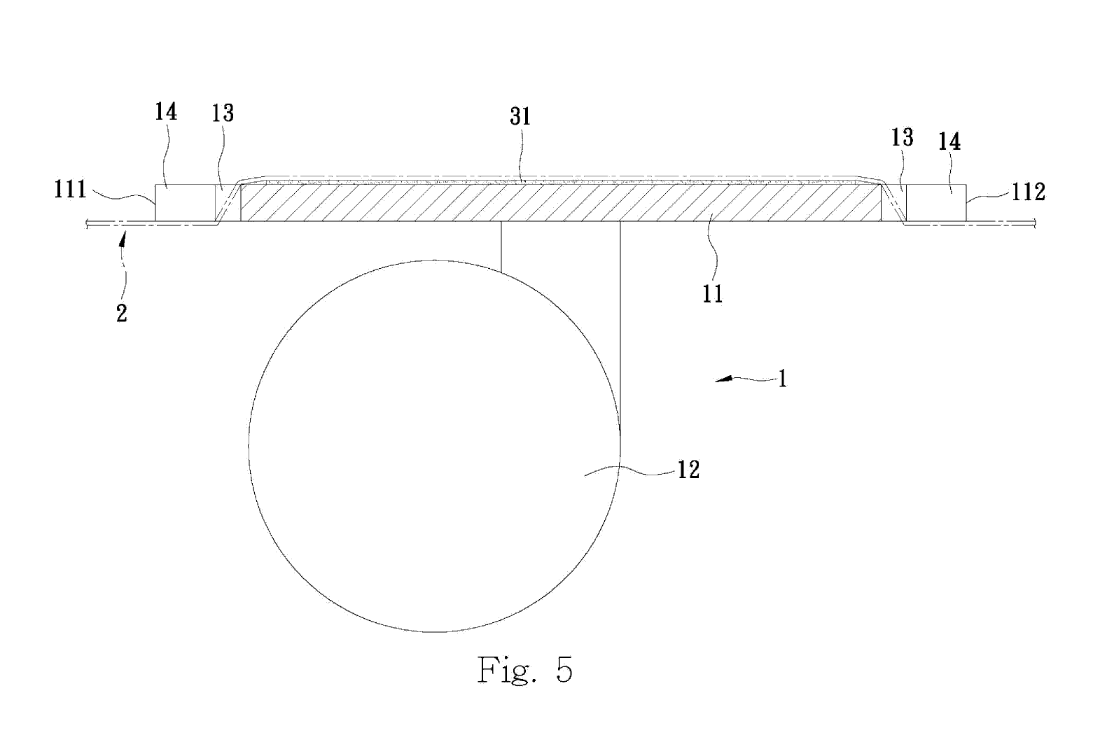

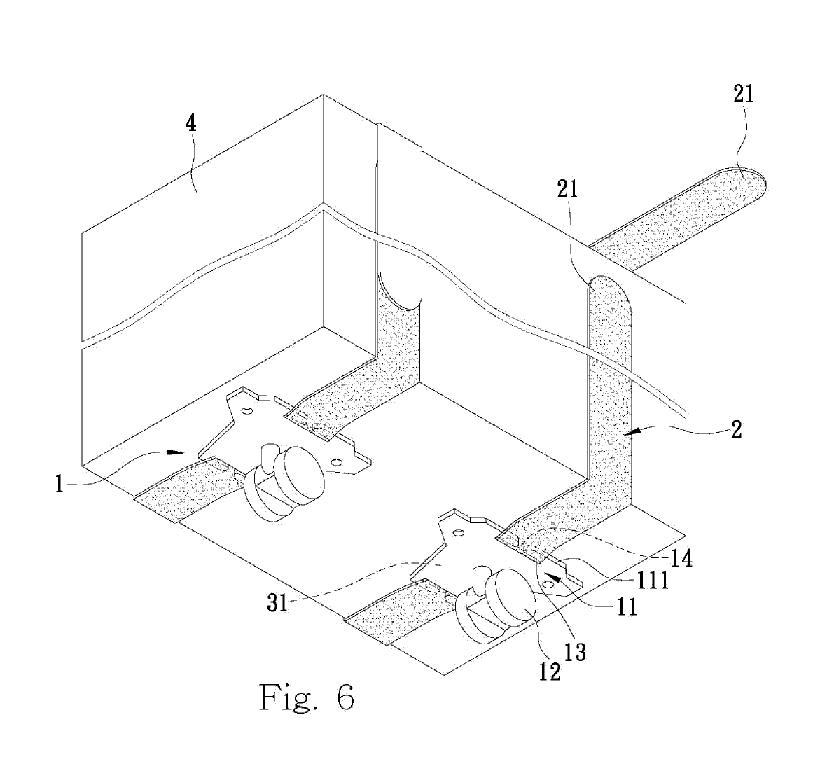

FIGS. 4-6 show the third embodiment of the invention. This embodiment differs from the second embodiment by adding a fastening unit 31 on the mount plate 11 for being fastened on the binding strip 2. This will increase stability between the binding strip 2 and the wheel set 1.

It will be appreciated by persons skilled in the art that the above embodiments have been described by way of examples only and not in any limitative sense, and that various alterations and modifications are possible without departure from the scope of the invention as defined by the appended claims.

What is claimed is:

1. A detachable wheel set for a case, comprising:
a binding strip removably binding up the case; and
a wheal set, having a mount plate and a wheel mounted thereon, and detachably fixed on the binding strip;
thereby the wheal set is detachably fastened on the case.

2. The detachable wheel set of claim 1, wherein the binding strip is a Velcro fastener.

3. The detachable wheel set of claim 2, further comprising:
a fastening unit, fixed on the mount plate and being a Velcro fastener corresponding to the binding strip, so that the fastening unit is removably fastened on the binding strip.

4. The detachable wheel set of claim 3, wherein the binding strip is either of a hook surface and a loop surface, and the fastening unit is the other either thereof.

5. The detachable wheel set of claim 3, wherein a majority of the binding strip is either of a hook surface and a loop surface, a distal portion of the binding strip is the other either thereof, and the fastening unit is the other either thereof.

6. The detachable wheel set of claim 1, wherein the mount plate is provided with two parallel slots penetrated through by the binding strip.

7. The detachable wheel set of claim 6, wherein the binding strip is a Velcro fastener.

8. The detachable wheel set of claim 7, wherein a majority of the binding strip is either of a hook surface and a loop surface, and a distal portion of the binding strip is the other either thereof.

9. The detachable wheel set of claim 7, further comprising:
a fastening unit, fixed on the mount plate and being a Velcro fastener corresponding to the binding strip, so that the fastening unit is removably fastened on the binding strip.

10. The detachable wheel set of claim 6, wherein the mount plate further comprises two openings separately communicating with the slots.
